(19) United States
(12) Patent Application Publication
(10) Pub. No.: US 2026/0295417 A1
(43) Pub. Date: Oct. 1, 2026

(54) INPUT DEVICE AND INPUT PROGRAM

(71) Applicant: NINTENDO CO. LTD., Kyoto-shi (JP)

(72) Inventor: Tomoyasu TAKA, Kyoto-shi (JP)

(21) Appl. No.: 19/465,962

(22) Filed: Jan. 30, 2026

(30) Foreign Application Priority Data
Mar. 28, 2025 (JP) 2025-055544

(51) Int. Cl. A63F 13/54; A63F 13/24; A63F 13/44; G06F 3/16

(52) U.S. Cl. CPC A63F 13/54; A63F 13/24; A63F 13/44; G06F 3/165; A63F 2300/638

(57) ABSTRACT

Input device includes at least one input button, and sound output unit configured to output first operation sound in response to first operation of pressing at least one input button and output second operation sound in response to second operation of releasing at least one input button. Second operation sound having first volume when elapsed time from first operation to second operation is first time, and second volume when elapsed time is second time longer than first time, first volume being lower than second volume.

### CROSS-REFERENCE TO RELATED APPLICATION

The disclosure of Japanese Patent Application No. 2025-055544, filed on Mar. 28, 2025, is incorporated herein by reference.

### BACKGROUND

The present disclosure relates to an input device including an input button, and an input program.

### SUMMARY

The input device and the input program according to one or more aspects of the present disclosure may have, for example, structures (1) to (8) below.
(1)

An input device according to an aspect of the present disclosure includes
at least one input button; and
a sound output unit configured to output a first operation sound in response to a first operation of pressing the at least one input button and output a second operation sound in response to a second operation of releasing the at least one input button,
the second operation sound having a first volume when the elapsed time from the first operation to the second operation is a first time, and a second volume when the elapsed time is a second time longer than the first time, the first volume being lower than the second volume.

The structure (1) can lower the volume of the second operation sound output from the sound output unit when the first operation sound and the second operation sound are output at a short interval. This can reduce the likelihood of mixture of the first operation sound and the second operation sound when the second operation sound overlaps the first operation sound.
(2)

In the structure according to (1),
the second operation sound may have a volume of zero when the second operation is performed before an end of an output of the first operation sound.

In the structure (2), the volume of the second operation sound is zero when the second operation is performed before the end of an output of the first operation sound. This can prevent overlapping of the second operation sound on the first operation sound, thus preventing mixture of the first operation sound and the second operation sound caused in response to operations on the input button.
(3)

In the structure according to (1) or (2),
the volume of the second operation sound becomes larger as the elapsed time becomes longer.

In the structure (3), the volume of the second operation sound is higher for a longer elapsed time. The user can thus easily identify the second operation sound when performing the second operation.
(4)

In the structure according to any one of (1) to (3),
the at least one input button may include a plurality of input buttons, and
when the sound output unit outputs the first operation sound in response to the first operation performed on a specific input button of the plurality of input buttons, the sound output unit may output the second operation sound in response to the second operation performed on the specific input button.

In the structure (4), both the first operation and the second operation are performed on a specific input button (in other words, on the same input button). In this case, the elapsed time tends to be shorter, and the second operation sound is likely to overlap the first operation sound. However, the structure (4) can lower the volume of the second operation sound output from the sound output unit for a shorter elapsed time. This can thus reduce the likelihood of mixture of the first operation sound and the second operation sound when the second operation sound overlaps the first operation sound.
(5)

In the structure according to any one of (1) to (4),
the first operation may be performed for selection of the at least one input button, and the second operation may be performed to confirm the selection.

The structure (5) allows, with the first operation sound, the user to identify selection of the input button performed by the first operation, and allows, with the second operation sound, the user to identify confirmation of the selection performed on the input button by the second operation.
(6)

In the structure according to any one of (1) to (5),
the second operation sound may have a lower volume than the first operation sound.

For many physical buttons such as push buttons including movable mechanical components, the operation sound generated by movement of such components in response to pressing on the button performed, for example, by a hand is larger than the operation sound generated by movement of such components in response to release of, for example, the hand from the button. In the structure (6), the volume of the second operation sound is lower than the volume of the first operation sound. In other words, the volume of the first operation sound is higher than the volume of the second operation sound. This structure allows the relationship in volume between the first operation sound and the second operation sound output from the sound output unit to be the same as the relationship in volume between the operation sound generated in response to pressing on a physical button and the operation sound generated in response to release from the physical button.
(7)

In the structure according to any one of (1) to (6),
the at least one input button may be a software key displayed on a display.

In the structure (7), the input button is a software key. In this case, an operation on the input button may be less identifiable by the user. However, the sound output unit outputs the first operation sound and the second operation sound in the structure (7), thus allowing the user to easily identify an operation on the input button.
(8)

One or more non-transitory computer-readable storage media having stored therein instructions that cause one or more processors to perform operations includes
causing a sound output unit to output a first operation sound based on a first operation of pressing an input button, and
causing the sound output unit to output a second operation sound based on a second operation of releasing the input button,
the second operation sound having a lower volume for an elapsed time from the first operation to the second operation being a first time than for the elapsed time being a second time, the second time being longer than the first time.

The input program (8) produces the same effects as the structure (1).

The input device and the input program according to one or more aspects of the present disclosure can reduce the likelihood of mixture of two operation sounds output when the input button is operated rapidly.

Additional benefits and advantages of the disclosed embodiments will be apparent from specification and Figures. The benefits and/or advantages may be individually provided by the various embodiments and features of the specification and drawings disclosure, and need not all be provided in order to obtain one or more of the same.

### BRIEF DESCRIPTION OF THE DRAWINGS

These and other objects and features of the present disclosure will become clear from the following description taken in conjunction with the preferred embodiments thereof with reference to the accompanying drawings, in which:

FIG. 1 is a schematic front view of an input device according to an embodiment of the present disclosure;

FIG. 2 is a block diagram of the input device according to the embodiment of the present disclosure showing its electrical configuration;

FIG. 3 is a graph schematically showing the volume of a first operation sound and the volume of a second operation sound for elapsed time;

FIG. 4 is a flowchart of an input process;

FIG. 5 is a graph schematically showing the volume of a first operation sound and the volume of a second operation sound for elapsed time in a modification;

FIG. 6 is a graph schematically showing the volume of the first operation sound and the volume of the second operation sound for elapsed time in a modification; and

FIG. 7 is a graph schematically showing the volume of the first operation sound and the volume of the second operation sound for elapsed time in a modification.

### DETAILED DESCRIPTION

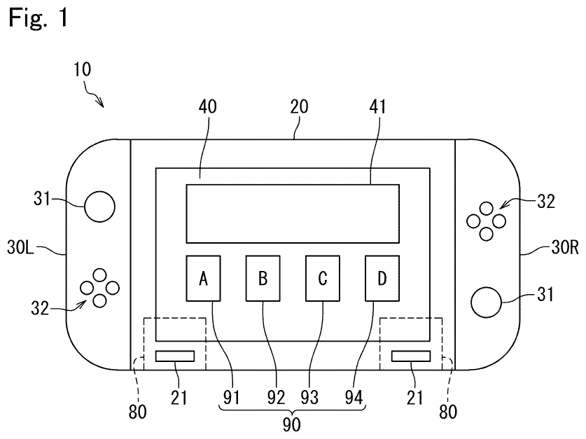

FIG. 1 is a schematic front view of an input device according to an embodiment of the present disclosure.

As shown in FIG. 1, an input device 10 is a game device in the present embodiment. The input device 10 is not limited to a game device. The input device 10 is any device that includes an input button (described later) and a sound output unit that outputs an operation sound in response to an operation on the input button. The input device 10 may be, for example, a smartphone or a personal computer. The input device 10 is an example of a computer.

The input device 10 includes a body 20, two controllers 30L and 30R attachable to and detachable from the body 20, and a display 40.

The external shape of the body 20 is substantially a rectangular prism. The external shape of the body 20 is not limited to a substantially rectangular prism.

The two controllers 30L and 30R are attached to the left and right ends of the body 20. The controllers 30L and 30R are detachable from the body 20. The controllers 30L and 30R may be attached to or detached from the body 20 with known methos such as fitting, sliding, and magnetic force. The input device 10 may include fewer or more than two controllers 30L and 30R. The input device 10 may include none of the controllers 30L and 30R.

The controllers 30L and 30R are used to operate the input device 10. The controllers 30L and 30R are connected to the body 20 with wires or wirelessly. Each of the controllers 30L and 30R includes, for example, a stick 31 and operation buttons 32 for operations.

The display 40 displays, for example, images and videos. The display 40 is installed in the body 20. The display 40 may or may not be installed in the input device 10. For example, the display 40 may be an external display such as a television. In this case, the input device 10 is connected to the external display, which then displays, for example, images and videos transmitted from the input device 10.

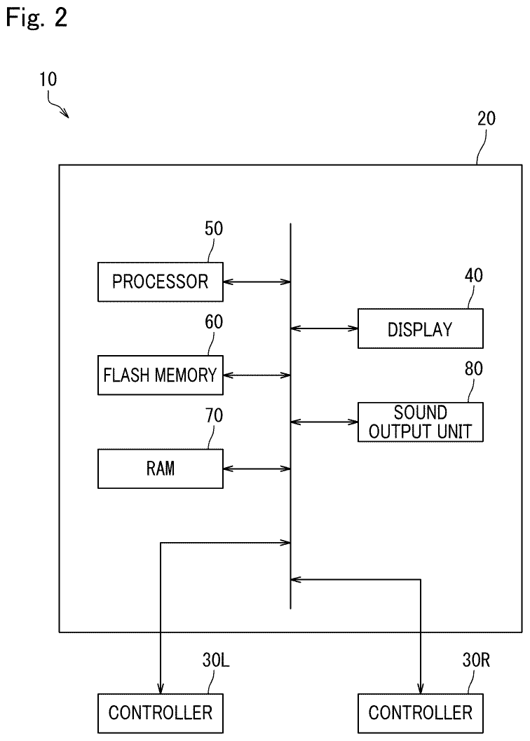

FIG. 2 is a block diagram of the input device according to the embodiment of the present disclosure showing its electrical configuration.

As shown in FIG. 2, the input device 10 includes a processor 50, a flash memory 60, a random-access memory (RAM) 70, and a sound output unit 80.

The processor 50, the flash memory 60, the RAM 70, and the sound output unit 80 are installed in the body 20. The controllers 30L and 30R, the display 40, the processor 50, the flash memory 60, the RAM 70, and the sound output unit 80 are electrically connected to one another directly or indirectly.

The processor 50 performs information processing for implementing various functions of the input device 10. The processor 50 includes at least one of, for example, a central processing unit (CPU), a microprocessing unit (MPU), a graphics processing unit (GPU), a digital signal processor (DSP), a field-programmable gate array (FPGA), a microcontroller unit (MCU), or an application-specific integrated circuit (ASIC).

The flash memory 60 is a nonvolatile memory. The flash memory 60 stores game application programs or firmware programs. In the present embodiment, the processor 50 executes an input program included in the game application programs or the firmware programs to implement an input process (described later).

The RAM 70 is a volatile memory. In the present embodiment, the RAM 70 temporarily stores, for execution, a game application and other information.

The sound output unit 80 is, for example, a speaker. The sound output unit 80 receives sound information generated through execution of an application program or a firmware program, and outputs the sound information outside. The sound output unit 80 is exposed outside the input device 10 through an opening 21 in the body 20 (refer to FIG. 1). This allows the sound output unit 80 to output sound outside the input device 10.

As described above, the display 40 displays, for example, images and videos. In FIG. 1, the display 40 displays input buttons 90 as examples of images and videos. The input buttons 90 are software keys displayed on the display 40. In the present embodiment, the display 40 displays four input buttons 90 (specifically, input buttons 91, 92, 93, and 94). The number of input buttons 90 is not limited to four.

In the present embodiment, the display 40 is a touchscreen. The display 40 can thus be pressed by, for example, a touch pen or a user's finger. Pressing one of the four input buttons 90 on the display 40 causes an output of information corresponding to the pressed input button 90.

For example, pressing the input button 91 causes an output of text information of a letter A and sound information indicating an operation sound. The text information is transmitted to the display 40 through the processor 50 or directly, causing the display 40 to display the letter A in a display area 41. The sound information is transmitted to the sound output unit 80 through the processor 50 or directly, causing the sound output unit 80 to output the operation sound. Similarly, pressing the input button 92 causes an output of text information of a letter B and sound information indicating an operation sound. Pressing the input button 93 causes an output of text information of a letter C and sound information indicating an operation sound. Pressing the input button 94 causes an output of text information of a letter D and sound information indicating an operation sound.

In the present embodiment, the same operation sound is output in response to pressing on any of the four input buttons 90. However, different operation sounds may be output in response to pressing on different input buttons 90. The same sound herein refers to sounds having the same pitch and tone. Different sounds herein refer to sounds differing in pitch or tone, or in both.

Pressing the display 40 (e.g., one of the input buttons 90 displayed on the display 40) includes, for example, any of the operations (A), (B), and (C) described below. The operation (A) is physically pressing the display 40. The operation (B) is touching the display 40. The operation (C) is changing, for example, the capacitance by changing the distance between the display 40 and, for example, a finger or a touch pen that is not in contact with the display 40. In the present embodiment, the display 40 is a touchscreen. Thus, pressing the display 40 corresponds to the operation (B).

The input process implemented by the input program being executed by the processor 50 will now be described. In the example described below, the input button 91 of the four input buttons 90 is pressed, and then the input button 91 is released. In this case, the input button 91 corresponds to a specific input button. When any of the other three input buttons 92, 93, and 94 is operated, the input program operates in the same manner as when the input button 91 is operated.

In response to a first operation of pressing the input button 91, first information corresponding to a first operation sound is transmitted from the input button 91 to the sound output unit 80. In response to a second operation of releasing the input button 91, second information corresponding to a second operation sound is transmitted from the input button 91 to the sound output unit 80. The sound output unit 80 outputs the first operation sound in response to reception of the first information, and outputs the second operation sound in response to reception of the second information. Each of the first information and the second information is sound information indicating an operation sound.

In the present embodiment, the first operation is performed, and then the second operation is performed. The first operation is performed for selection of the input button 91. The second operation is performed to confirm the selection performed by the first operation.

In response to the first operation, the first information is transmitted to the sound output unit 80. In response to the second operation performed after the first operation, the second information is transmitted to the sound output unit 80. The sound output unit 80 thus outputs the first operation sound first and then the second operation sound. More specifically, in response to the operation of pressing and then releasing the input button 90, the sound output unit 80 basically outputs the operation sound twice. As described later, the sound output unit 80 may output the first operation sound without outputting the second operation sound.

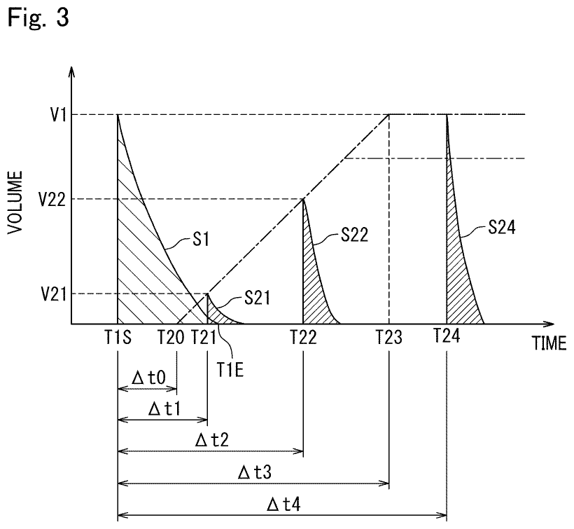

FIG. 3 is a graph schematically showing the volume of the first operation sound and the volume of the second operation sound for elapsed time.

With reference to FIG. 3, changes in the volume of the second operation sound for elapsed time from the first operation to the second operation will be described.

In FIG. 3, S1 represents a schematic waveform of the first operation sound, and S21, S22, and S24 each represent a schematic waveforms of the second operation sound.

In FIG. 3, the first operation is performed at time T1S, causing the sound output unit 80 to output the first operation sound S1.

The volume of the second operation sound differs based on the time elapsed from the first operation.

For example, in response to the second operation performed at time T21 at which Δt1 has elapsed from the first operation, the sound output unit 80 outputs the second operation sound S21. For example, in response to the second operation performed at time T22 at which Δt2 longer than Δt1 has elapsed from the first operation, the sound output unit 80 outputs the second operation sound S22.

The second operation sound S22 has a higher volume than the second operation sound S21. In this case, the elapsed time Δt1 corresponds to a first time, and the elapsed time Δt2 corresponds to a second time. More specifically, the second operation sound S21 for the elapsed time Δt1 has a lower volume than the second operation sound S22 for the elapsed time Δt2.

In FIG. 3, the volume of the first operation sound is the maximum value in the waveform of the first operation sound, and the volume of the second operation sound is the maximum value in the waveform of the second operation sound. In FIG. 3, for example, the first operation sound S1 and the second operation sound S24 each have a volume of V1, the second operation sound S21 has a volume of V21, and the second operation sound S22 has a volume of V22. The second operation sound can have different volumes based on the elapsed time from the first operation. In FIG. 3, the volume of the second operation sound corresponding to the elapsed time is indicated by the dot-dash line. Each of the volume of the first operation sound and the volume of the second operation sound is not limited to the maximum value in the corresponding waveform, and may be, for example, an average of volumes at multiple times in the corresponding waveform or an integral of the corresponding waveform.

In the present embodiment, the volume of the second operation sound is higher for a longer elapsed time in a time domain between time T20, at which Δt0 has elapsed from the first operation, and time T23, at which Δt3 has elapsed from the first operation. In contrast, the volume of the second operation sound is constant in a time domain for which the elapsed time from the first operation is longer than Δt3 (in other words, in a time domain after time T23).

The elapsed time Δt0 is, for example, a minimum value that allows the input device 10 to identify the first operation and the second operation as different operations. More specifically, the input device 10 cannot identify the second operation when the elapsed time from the first operation to the second operation is less than Δt0.

The elapsed time Δt3 can be set to any value. For example, the elapsed time Δt3 from the first operation is set to allow the second operation sound to have the same volume as the first operation sound as shown in FIG. 3.

In the present embodiment, the second operation sound has the same volume V1 as the first operation sound independently of the elapsed time when the elapsed time from the first operation is longer than Δt3 (in other words, after time T23). FIG. 3 shows the second operation sound S24 for an elapsed time Δt4 from the first operation as an example of the second operation sound for the elapsed time from the first operation longer than Δt3. In this case, the volume V1 of the second operation sound S24 is higher than the volume V21 of the second operation sound S21. Thus, the elapsed time Δt1 corresponds to the first time, and the elapsed time Δt4 corresponds to the second time. Similarly, the volume V1 of the second operation sound S24 is higher than the volume V22 of the second operation sound S22. Thus, the elapsed time Δt2 corresponds to the first time, and the elapsed time Δt4 corresponds to the second time.

The volume of the second operation sound for the elapsed time from the first operation longer than Δt3 may be higher than the volume V1 of the first operation sound.

The volume of the second operation sound for the elapsed time from the first operation longer than Δt3 may be lower than the volume V1 of the first operation sound, as indicated by the two-dot dash line in FIG. 3. In this case, the volume of the second operation sound is lower than the volume V1 of the first operation sound independently of the elapsed time from the first operation.

The volume of the second operation sound for the elapsed time from the first operation longer than Δt3 may or may not be constant.

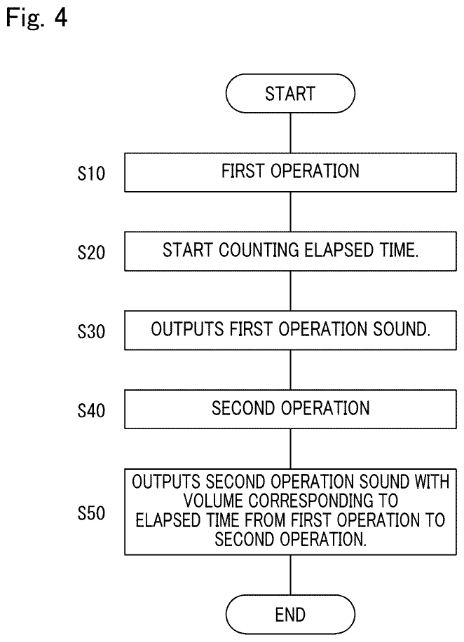

FIG. 4 is a flowchart of the input process.

With reference to FIG. 4, an example of the input process performed by the input device 10 will now be described. In this example, the input button 91 is pressed and then released.

In response to the first operation of pressing the input button 91 (S10), the first information corresponding to the first operation sound is transmitted from the input button 91 to the sound output unit 80. The counting of the elapsed time from the first operation is started (S20). The sound output unit 80 outputs the first operation sound corresponding to the received first information (S30). In response to the second operation of releasing the input button 91 (S40), the second information corresponding to the second operation sound is transmitted from the input button 91 to the sound output unit 80. The information about the volume of the second operation sound included in the second information is determined based on the elapsed time from the first operation to the second operation, such as the elapsed time described with reference to FIG. 3. The sound output unit 80 outputs the second operation sound corresponding to the received second information. More specifically, the sound output unit 80 outputs the second operation sound with the volume corresponding to the elapsed time from the first operation to the second operation (S50). The elapsed time is reset to zero at the time after the volume of the second operation sound included in the second information is determined.

In the above embodiment, as shown in FIG. 3, the elapsed time Δt0 from the first operation is shorter than the duration from time T1S, at which the first operation is performed to start an output of the first operation sound S1, to time T1E at which the output of the first operation sound S1 ends. In the above embodiment, the second operation sound thus overlaps the first operation sound S1 when the second operation is performed before time T1E and the second operation sound is output. As shown in FIG. 3, for example, the second operation sound S21 output before time T1E partially overlaps the first operation sound S1.

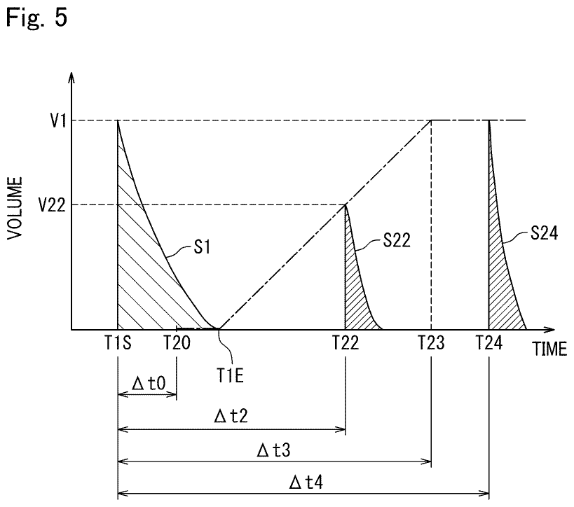

In contrast, as shown in FIG. 5, the second operation sound may have a volume of zero when the second operation is performed before time T1E at which an output of the first operation sound S1 ends. FIG. 5 is a graph schematically showing the volume of the first operation sound and the volume of the second operation sound for elapsed time in a modification. In this case, the second operation sound does not overlap the first operation sound S1.

The first operation sound and the second operation sound may be different or the same. In the above embodiment, the first operation sound and the second operation sound are different. This sound difference is shown in FIGS. 3 and 5 by using different shapes for the schematic waveform of the first operation sound S1 and the schematic waveforms of the second operation sounds S21, S22, and S24.

In the above embodiment, as shown in FIGS. 3 and 5, the volume of the second operation sound is higher for a longer elapsed time in the time domain before time T23 at which Δt3 has elapsed from the first operation. However, the volume of the second operation sound can be higher in any manner other than the manner shown in FIGS. 3 and 5.

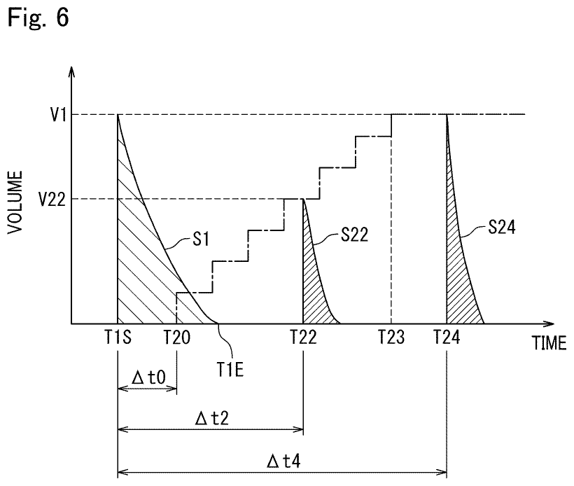

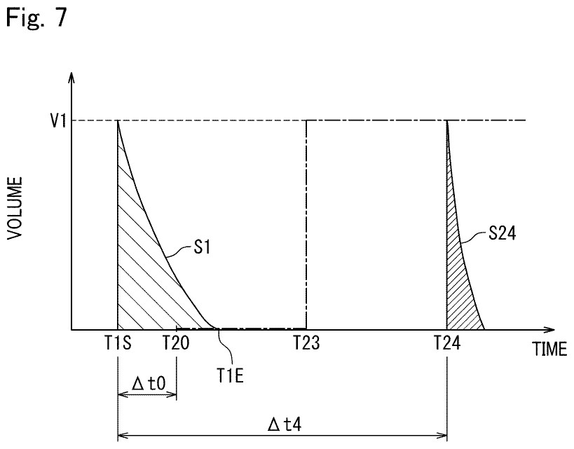

FIGS. 6 and 7 are graphs each schematically showing the volume of the first operation sound and the volume of the second operation sound for elapsed time in a modification.

As shown in FIG. 6, for example, the volume of the second operation sound may be higher in a stepwise manner in the time domain before time T23.

As shown in FIG. 7, for example, the volume of the second operation sound may be constant in the time domain before time T23. In this case, the elapsed time from the first operation to a time before time T23 corresponds to the first time, and the elapsed time from the first operation to a time after time T23 corresponds to the second time. In FIG. 7, the volume of the second operation sound is zero in the time domain before time T23. However, the volume of the second operation sound before time T23 may or may not be zero.

In the above embodiment, the input button 91 is pressed and then released. More specifically, in the above embodiment, the pressed input button 90 is the same as the released input button 90. However, the pressed input button 90 may be different from the released input button 90.

For example, the input button 91 may be pressed by a finger touch on the display 40, and then the finger touching the display 40 may move from the position of the input button 91 to the position of the input button 92 to be released from the input button 92. In this case, the input button 91 is pressed, and then the input button 92 is released. More specifically, the pressed input button 90 is different from the released input button 90.

In this example, the first operation of pressing the input button 91 causes the sound output unit 80 to output the first operation sound, and the second operation of releasing the input button 92 causes the sound output unit 80 to output the second operation sound.

In the above embodiment, the input buttons are the software keys displayed on the display 40. However, the input buttons are not limited to software keys, and may be physical buttons. The physical buttons are, for example, push buttons such as the operation buttons 32 on the controllers 30L and 30R.

The embodiments and modifications described above may be combined as appropriate with one another to produce their advantageous effects.

What is claimed is:

1. An input device, comprising:
at least one input button; and
a sound output unit configured to output a first operation sound in response to a first operation of pressing the at least one input button and output a second operation sound in response to a second operation of releasing the at least one input button,
the second operation sound having a first volume when the elapsed time from the first operation to the second operation is a first time, and a second volume when the elapsed time is a second time longer than the first time, the first volume being lower than the second volume.

2. The input device according to claim 1, wherein
the second operation sound has a volume of zero when the second operation is performed before an end of an output of the first operation sound.

3. The input device according to claim 1, wherein
the volume of the second operation sound becomes larger as the elapsed time becomes longer.

4. The input device according to claim 1, wherein
the at least one input button includes a plurality of input buttons, and
when the sound output unit outputs the first operation sound in response to the first operation performed on a specific input button of the plurality of input buttons, the sound output unit outputs the second operation sound in response to the second operation performed on the specific input button.

5. The input device according to claim 1, wherein
the first operation is performed for selection of the at least one input button, and the second operation is performed to confirm the selection.

6. The input device according to claim 1, wherein
the second operation sound has a lower volume than the first operation sound.

7. The input device according to claim 1, wherein
the at least one input button is a software key displayed on a display.

8. One or more non-transitory computer-readable storage media having stored therein instructions that cause one or more processors to perform operations comprising:
causing a sound output unit to output a first operation sound based on a first operation of pressing an input button; and
causing the sound output unit to output a second operation sound based on a second operation of releasing the input button,
the second operation sound having a first volume when the elapsed time from the first operation to the second operation is a first time, and a second volume when the elapsed time is a second time longer than the first time, the first volume being lower than the second volume.
